(19) United States
(12) Patent Application Publication
(10) Pub. No.: US 2008/0313090 A1
(43) Pub. Date: Dec. 18, 2008

(54) Interaction-management methods and platform for client-agent interaction-related environments

(76) Inventors: Leonid Portman, Rishon Lezion (IL); Omri Hayner, Moshav Hagala (IL); Ronit Ephrat, Tel-Aviv (IL); Itay Grushka, Shoham (IL); Dvir Hoffman, Kfar Saba (IL); Hadas Liberman Ben-Ami, Netanya (IL)

Correspondence Address: Pearl Cohen Zedek Latzer, LLP, 1500 Broadway, 12th Floor, New York, NY, 10036, US

(21) Appl. No.: 11/812,280

(22) Filed: Jun. 18, 2007

(51) Int. Cl. H04L 9/00

(52) U.S. Cl. 705/80

(57) ABSTRACT

A platform for enabling collaboration of components of a distributed interaction-related loosely-coupled system, and a method thereof are provided. The platform includes a communication medium and interaction-related business services capable of communicating via the communication medium using an interaction management protocol. The platform further includes one or more business process management services to create one or more business flows that utilize one or more of said business services

### BACKGROUND OF THE INVENTION

In an interaction-related environment, such as call center or contact center, a vast number of client-agents interactions and internal interactions involving personnel of the contact center are being held on a daily basis. The systems and applications within the interaction-related environment are responsible for various business flows and hold valuable data. The technological infrastructure may include products from various vendors, each of which may be operated, interfaced and managed separately For example, retrieving stored customer details may involve one software and/or hardware component, playback of stored calls may involve another component and viewing agents activity may involve yet a third component. There is a need for a platform that would enable managing these systems efficiently, enabling data sharing and/or data analysis, as well as the creation of new business flows, procedures and reports.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a high level block diagram of an interaction-related system according to an exemplary embodiment of the present invention;

FIG. 2 is a block diagram of exemplary communication architecture according to some embodiments of the present invention;

FIG. 3 is a flowchart diagram illustrating an exemplary flow according to some embodiments of the present invention;

FIG. 4 is a flowchart diagram illustrating an exemplary flow according to some embodiments of the present invention; and

FIG. 5 is a flowchart diagram illustrating an exemplary flow according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details ale set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g, electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations

Some embodiments of the present invention are directed to client-agent interaction-related systems, such as call centers or contact centers. In an exemplary client-agent interaction-related environment agents may interact with clients over the telephone network or the Internet and may execute further actions, such as place orders for products, provide information, or log customers' details. Additional interactions may include internal interactions between personnel. In addition, a typical interaction-related system may comprise platforms and applications providing functionalities and capabilities such as, for example, recording of conversations or events, scheduling of agents' shifts, monitoring of agents activity, analysis tools and performance monitoring. These platforms and applications may be used by the agents as well as by the management and administration of the interaction-related system.

It should be understood to a person skilled in the art that some embodiments of the present invention may be applicable to environments such as trading floors, financial institutions such as banks, or other business organizations. Other environments that may be suitable for employing embodiments of the present invention may be government agencies, network operators or other communication infrastructure operators, for example, cellular or wired phone networks operators.

The technological infrastructure of interaction-related systems typically comprises computer systems, computer software systems, network equipment, storage systems, archiving systems, backup systems and audio or video recording and playback systems. The technological infrastructure may provide functionalities and features such as security enforcement, recording and playback of calls as well as recording and playback of screen activities, work force management, system configurations, performance management, quality monitoring, auditing, and activity monitoring as well as user interface to enable human interaction with the above listed services and features.

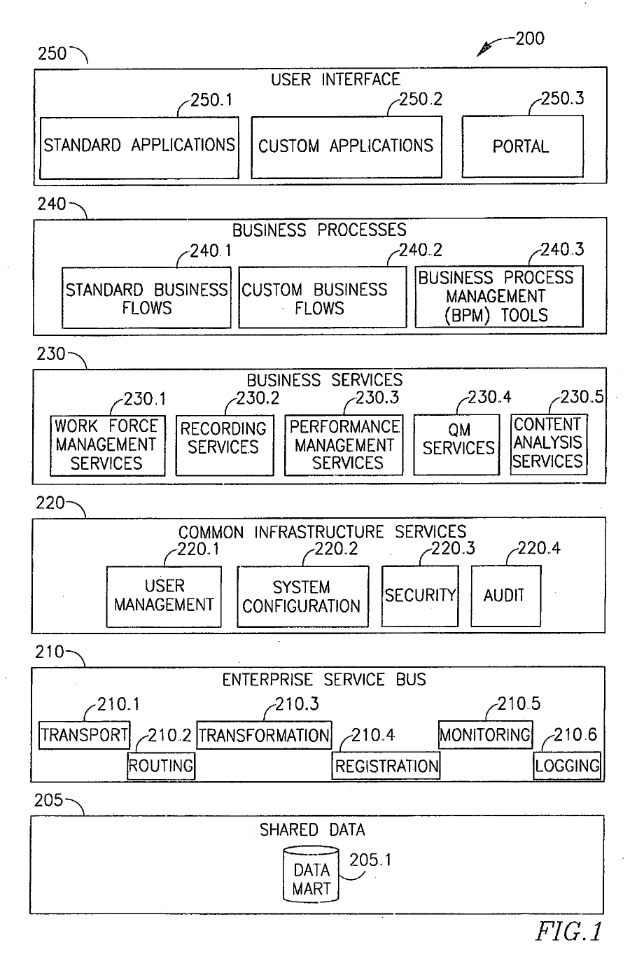

Reference is now made to FIG. 1 which is a logical block view of an exemplary interaction-relation environment according to embodiments of the present invention. The interaction-relation environment may be a contact center, a call center or any other environment involving client-agent interactions as internal personnel interactions. This exemplary embodiment may include a tier-based interaction-management platform (or system) 200, implementing an interaction management protocol where each tier may comprise services which may be requested by other components of system 200. Typically, but not necessarily, services from the upper tiers may request services associated with the same tier or lower tiers. System 200 may include a shared data tier 205, a communication medium tier 210, a common infrastructure services tier 220, a business services tier 230, a business processes tier 240 and a user interface services 250. According to embodiments of the present invention, interaction management platform 200 may provide, a brokered service environment to free components of the interaction-related environment from the need to know or deal with certain aspects of a service they require, for example who provides the service, where the provider is or what is the provider's address, as well as various aspects regarding the way provision is implemented.

A service may be an execution of one or more computer programs that may provide some functionality. A service provider may return results to a service consumer in the form of a simple indication of success or failure of the service execution or data of various types such as audio stream, an image, a reference to a specific data location, a text string, or a list, such as, for example a list of currently active agents in the interaction-related system. Services may be invoked or interfaced using standard communication protocols such as for example simple object access protocol (SOAP) or hyper text transfer protocol (HTTP). According to embodiments of the invention, the format and sequence of messages exchanged between service providers and service consumers may be predefined, as part of system 200 by the interaction management protocol.

According to embodiments of the present invention, tier-based system architecture 200 may be implemented using Service oriented architecture (SOA). Service oriented architecture (SOA) is an architectural approach for creating systems built from autonomous services Using the SOA principals enables creating an environment having loosely-coupled systems that may be integrated while maintaining their autonomous identity as disparate systems. The loosely-coupled systems may share services developed in different programming languages and hosted on disparate platforms with a variety of security models and business processes

Shared data tier 205 may comprise one or more storage units 205.1 to provide shared data storage services. A non-exhaustive list storage services may include storing data in storage, retrieving data from storage, verifying data integrity and querying. According to embodiments of the present invention, upper tiers 210, 220, 230, 240 and 250 may request data storage services from components of shared data tire 205.

Communication medium tier 210 may provide communication and integration infrastructure. Communication medium 210 may be a message-oriented medium, namely, the communication between the components of system 200 may be executed by transferring messages over communication medium 210 According to embodiments of the present invention, components of system 200 may use further entities and interfaces defined by the interaction management protocol to enable efficient communication between various services of system 200. For example, components from various vendors may communicate easily and different versions of services may also communicate with one another using this protocol. Defining business flows that use and aggregate more than one system and sharing data efficiently may be greatly simplified by the interaction management protocol. According to embodiments of the present invention, the use of communication medium 210 as an enterprise service bus may eliminate the need for direct point-to-point communication between each pair of components or systems within the interaction-related environment.

According to embodiments of the present invention, communication medium 210 may be implemented as an enterprise service bus (EBS). Examples for a product that may provide such capabilities may be BizTalk Server of Microsoft, Oracle's Fusion and/or WebSphere of IBM.

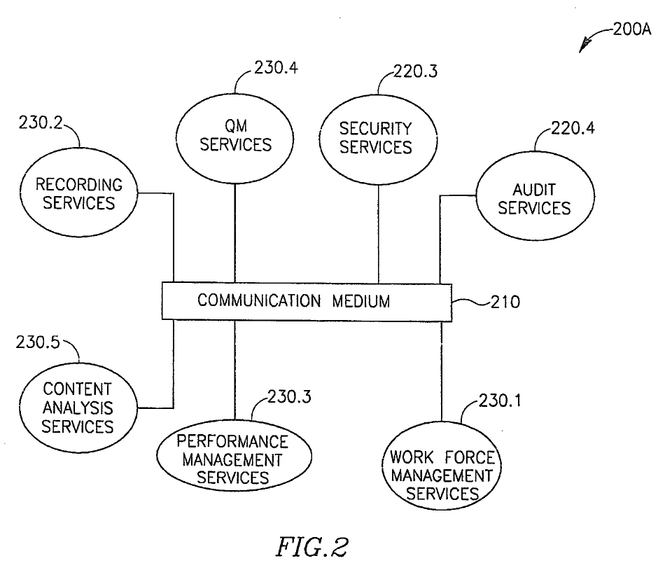

Reference is additionally made to FIG. 2 which is a logical view of an exemplary communication architecture enabling any component supporting the interaction management protocol according to embodiment of the present invention to communicate with any other component supporting that protocol. It should be noted that services may be communicated through communication medium tier 210 using standard communication protocols, such as web services (SOAP and HTTP). According to embodiments of the invention, the services may use the interfaces defined by the interaction management protocol as another layer of standardization on top of communication medium tier 210. For simplicity, in the exemplary interaction-related system 200A, only some components and services connected to communication medium 210 are shown. As depicted in FIG. 2, for example, both recording services 230.2 and performance management services 230.3 are coupled to communication medium 210. Accordingly, the recording system and the performance management application may communicate with each other and with other components over communication medium 210 using the inter action management protocol.

Referring back to FIG. 1, according to embodiments of the present invention, some of the services provided by communication medium 210 may be specifically requested by components of the system 200 while other may be part of the functionality of communication medium 210 Communication bus 210 may provide various services such as transport services 210.1, touting services 210.2, transformation services 210.3, registration services 210.4, monitoring services 210.5 and logging services 210.6 It should be understood to a person skilled in the art that embodiments of the invention are not limited to exemplary services 210.1-210.6 and other services may be provided by communication medium 210.

Communication medium 210 in the embodiments of the present invention may serve as a fundamental block in the brokered service environment. Components of system 200 may register services they may provide while possibly other components requiting services may request them without prior registration.

According to embodiments of the invention, transport service 210.1 may include standard protocols such as web services (WS) and/or file transfer protocol. Such protocols may be used for transferring data between various components of system 200, as known in the art

Routing 210.2 may enable service requests to be routed to a service provider, possibly based on a registration of service providers with communication medium 210. Service providers may register with communication medium 210 A registration may comprise a list of services provided by the registering module. Communication medium 210 may transfer service requests to a registered module base on such registration. Service consumers may register with communication medium 210 as well. For example, Service consumers may be notified of new available services based on registration. Routing 210.2 may relieve a service consumer of the need to be aware of who provides a service. According to some embodiments of the invention, in order to invoke a service, a service consumer may simply communicate a service request to communication medium 210 which may in turn route the service request to the appropriate service provider. According to some embodiments of the invention, a module connected to communication medium 210 may register to receive messages based on messages content. For example, a connected module may register with communication medium 210 in order to receive messages containing alerts.

Transformation service 210.3 may guarantee unified data representation, handling issues such as but not limited to, XML schema transformation An additional exemplary service provided by communication medium 210 is registration service 210.4 which may enable the discovery of components and services within system 200 by components of system 200. According to embodiments of the invention, when a component of system 200 registers with communication medium 210 other components of system 200 may be notified of its presence as well as the services this newly registered component provides. Registration service 210.4 may hold an updated list of all components and services currently registered with communication medium 210 thus maintaining the ability to respond to queries regarding the availability of components and/or services.

Monitoring service 210.5 may enable monitoring of various parameters of system 200. A non-exhaustive list of parameters may include data rate, message volume and message distribution per component Logging service 210.6 may log various aspects and parameters associated with system 200, such as, but not limited to, events, alarms and statistics. Logging service 210.6 may be called upon in various ways, such as, but not limited to, periodically, specific request to start logging or by predefined rules. The rules may be associated with various thresholds, various executed services and the like.

According to embodiments of the present invention, common infrastructure services tier 220 may include, for example, a user management service 220.1 to handle the users of system 200, system configuration services 220.2, security services 220.3, and audit services 220.4. It should be understood to a person skilled in the art that embodiments of the invention are not limited to exemplary services 220.1-220.4 and other services may be provided by common infrastructure services 220

User management service 220.1 may provide services, such as, but not limited to, defining new users, defining user privileges and hierarchy, defining user groups, defining user passwords, user's state, namely, active/inactive state and users profiles. User management service 220.1 may also provide, possibly upon request, information, such as, but not limited to, user profiles, user privileges and user state. According to embodiments of the present invention, users may be defined in system 200 by user management service 220.1. Once defined, a user may request a service or functionality in the entire system 200. According to embodiments of the invention, a central user database may be kept by user management service 220.1. Alternatively, required data may be kept at various databases. Components of system 200 that require, for example, authenticating a user, may access this database by, for example, sending a service request to user management service 220.1 to retrieve the user profile in order to determine attributes, such as, but not limited to, privileges, credentials or access rights.

According to embodiments of the invention, system configuration 220.2 may use the interaction management protocol supported also by other components in system 200 and may provide an interface to configure configurable components and parameters in system 200. This unification of the management component may serve to greatly simplify the configuration task of the interaction-related sub-systems and components of system 200

According to embodiments of the present invention, security service 220.3 may provide authentication and authorization services to the interaction management platform 200. Security service 220.3 may enable system 200 to handle sensitive data including data required by the authorities to be protected. Money transactions, credit card numbers and shopping lists are a few examples out of many. In addition compliance to various laws and regulations may dictate security enforcement at various levels of the interaction-related system covering aspects, such as, but not limited to, data storage, data transfer, users access rights and privileges, data validation, various auditing, authorization and system deployment.

Security service 220.3 may bring unification of security aspects such as but not limited to security enforcement, user authentication, determining user credentials, and access rights. This unification may be made possible according to embodiments of the present invention, as shown in FIG. 1, where components of system 200 may request services from other components in system 200 with many of the security aspects of the interaction-related systems operation viewed as services, thus for example, defining a new user's privileges may be a service provided by security service 220.3, authenticating a user in order to allow or deny access is another exemplary service security service 220 may provide to other components of system 200, and verifying user credentials is yet another exemplary service.

Security service 220.3 may provide, for example, translation services for security schemas which may vary from a first component of system 200 to another component of the system, thus enabling different components of system 200 to exchange security information even though various aspects of the information may be represented differently by each component. Audit service 220.4 may provide auditing services to components of system 200, such as, but not limited to, software components, processes or flows under different scenarios

According to embodiments of the invention, business services tier 230 may include for example, work force management services 230.1, recording services 230.2, performance management services 230.3, Quality management (QM) services 230.4 and Content Analysis services 230.5, all of which are detailed below. It should however be understood to a person skilled in the art that embodiments of the invention are not limited to exemplary services 230.1-230.5 and other services, such as client relation management (CRM) services, accounting services and others may be provided by business services tier 230.

Work force management services 230.1 may handle tasks, such as, but not limited to, shift scheduling of agents, real time adherence to planned schedule, and event scheduling.

Recording service 230.2 may handle recording of various events and activities in system 200, such as, but not limited to, recording of telephonic and web-based client-agent interaction, computer display snapshots, or other recordable forms of activities, states, events or processes. Recording service 230.2 may also provide services related to recorded and/or stored data, such as, but not limited to, searches for recording, requests for playback of recorded information, archiving, deleting or other manipulations of recorded information.

Performance management service 230.3 may be a predefined set of chosen factors that directly or indirectly influence the effectiveness of a product or process, as known in the art. Examples for such factors in the interaction-related system environment may be average call duration, percentage of sales per call and customer wait time. Performance management service 230.3 may provide services, such as, but not limited to, performance management calculation, model building, real time dials showing performance meters, and performance reports, displays and alerts. In the context of embodiments of the present invention, performance management service 230.3 may communicate with other components of system 200 over communication medium 210.

The possibility to communicate with other components of system 200 may enables performance management service 230.3 to perform more efficiently. According to embodiments of the present invention, a host of parameters, measures and data types may be available to performance management service 230.3, many of which are inaccessible to performance management systems running in conventional interaction-related environment architecture. For example, performance management service 230.3, may alert a supervisor when low call rate is detected. Such alerts may be, for example, specific to an agent or per a group of agents.

Quality management (QM) services 230.4 may provide interfaces and services for quality monitoring and quality improvement, such as, but not limited to, creating operational evaluation measures. For example, QM 230.4 may provide a coaching session for an agent.

Content analysis services 230.5 may provide analytics services that include, for example, creating analytics rules that may determine which calls will be analyzed and by which analytic algorithm. A non-exhaustive list of content analysis algorithms may include word spotting, speech-to-text, emotion detection, talk over, or phonetics. According to embodiments of the invention, content analysis services 230.5 may further provide services for analyzing a specific interaction, generating categorizations of interactions and query investigations. Content analysis services 230.5 may use services from other components of system 200 for its tasks.

According to embodiments of the invention, content analysis services 230.5 may communicate with other components of system 200 over communication medium 210. According to embodiments of the present invention, content analysis services 230.5 may trigger events throughout the system. For example, upon identifying an agitated customer, content analysis services 230.5 may use services in order to alert a supervisor to act, or trigger recording of a specific inter action by requesting a service from recording services 230.2 when a predefined condition is identified by a content analysis application.

Business processes tier 240 may be a way of automating, aggregating and collaborating business entities, for example, services, flows and procedures. Business process tier 240 may include the definition as well as possibly scripts and computer programs which may be required in order to execute its tasks. Business process tier 240 may provide functionalities that may incorporate different components of system 200. Tier 240 may include business flows and procedures that may be activated in various ways, for example, by an operator of the system, automatically upon detection of a predefined condition by a component of system 200, or periodically. Business process tier 240 may also provide tools for defining new business flows and procedures. According to embodiments of the invention, business process tier 240 may include for example, standard business flows 240.1, customized business flows 240.2 and process management services 240.3, all of which are detailed below.

Standard business flows 240.1 may be a set of standard, predefined business flows that may be supplied with or built-in the system. Customized business flows 240.2 may be a set of new business flows that may use and aggregate one or more systems within the interaction-related environment. The customized business flows may be implemented according to specific requirements and may be dynamically modified based on the changing requirements and needs. Business process management services 240.3 may be a set of tools used to create new business flows and procedures. A non-exhaustive list of tools may include tools for business activity monitoring, tools to control business flows, tools to create and configure business flows.

User interface tier 250 may provide the operator of the system with a user interface. User interface tier 250 may include standard “off-the-shelf” applications 250.1, customized applications 250.2 and portal services 250.3 which may be a standard or default interface, such as, for example, a web browser

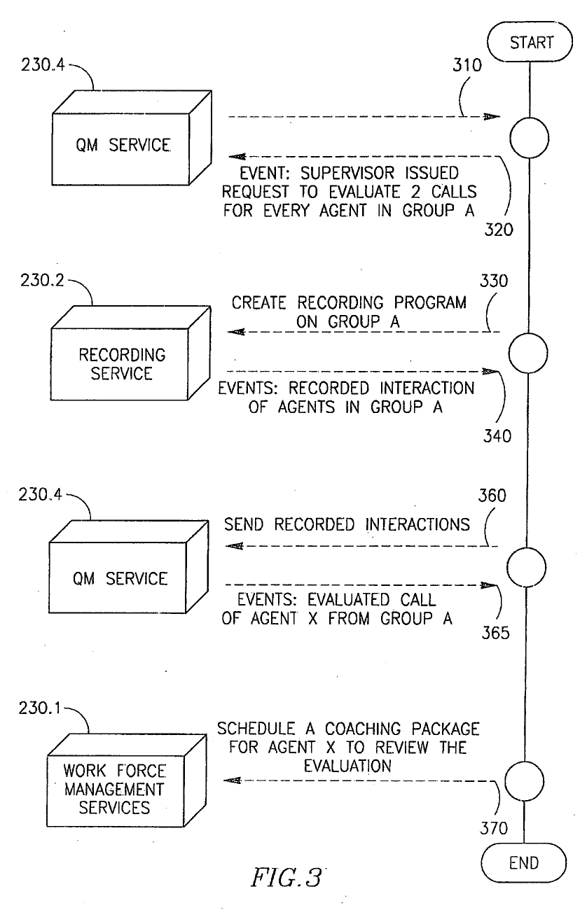

FIGS. 3, 4 and 5 illustrate exemplary business processes within interaction management platform 200 according to exemplary embodiments of the present invention. It should be understood to a person skilled in the art that embodiments of the present invention are not limited to the exemplary business flows depicted herein and that embodiments of the present invention may be implemented with other suitable business flows.

Reference is now made to FIG. 3, which depicts an exemplary business flow according to embodiments of the present invention. The exemplary business flow of FIG. 3 may enable a supervisor of a contact center to define an evaluation form and to request usage of this form to evaluate a predefined number of client-agent interactions for a predefined group of agents. The business flow is defined as follows: First, using quality management (QM) service 230.4, an evaluation form is created and an event message notifying the creation of the evaluation form is being sent over communication medium 210 using the interaction management protocol (arrow 310). Evaluation form may define, among other things, the methods and criteria by which to evaluate agents, for example, the number of recordings to perform for each agent being evaluated, and various criteria by which to evaluate recorded calls, for example call duration and/or call outcome.

The procedure may be initiated manually by an operator, for example a supervisor or automatically requesting QM service 230.4 to use the evaluation form to evaluate a predefined number of calls (e.g. 2 calls) for each agent associated with a predetermined group of agents. Next, a request to use the evaluation form initiated by QM service 230.4 is being delivered over communication medium 210 using the interaction management protocol (arrow 320). Accordingly, the request initiated by QM 230.4 may include a request for a recording service from recording services 230.2.

Consequently, a recording program may be created and delivered to recording services 230.2 over communication medium 210 using the interaction management protocol (arrow 330). As a result of the recording program, the requested client-agent interactions may be recorded and recording services 230.2 may return the recorded data over communication medium 210 using the interaction management protocol (arrow 340). The recorded client-agent interaction may be sent to QM services 230.4 (arrow 360). QM services 230.4 may perform the task of evaluating the recordings. Once the evaluation on a particular agent is completed, QM services 230.4 may send an event message over communication medium 210 using the interaction management protocol notifying that the evaluation of the agent was completed (arrow 365).

Consequently, a request to schedule a meeting between the agent and his supervisor to review the evaluation form may be sent to work force management service 230.1 over communication medium 210 using the interaction management protocol (arrow 370). As a result, work force management service 230.1 may schedule the meeting.

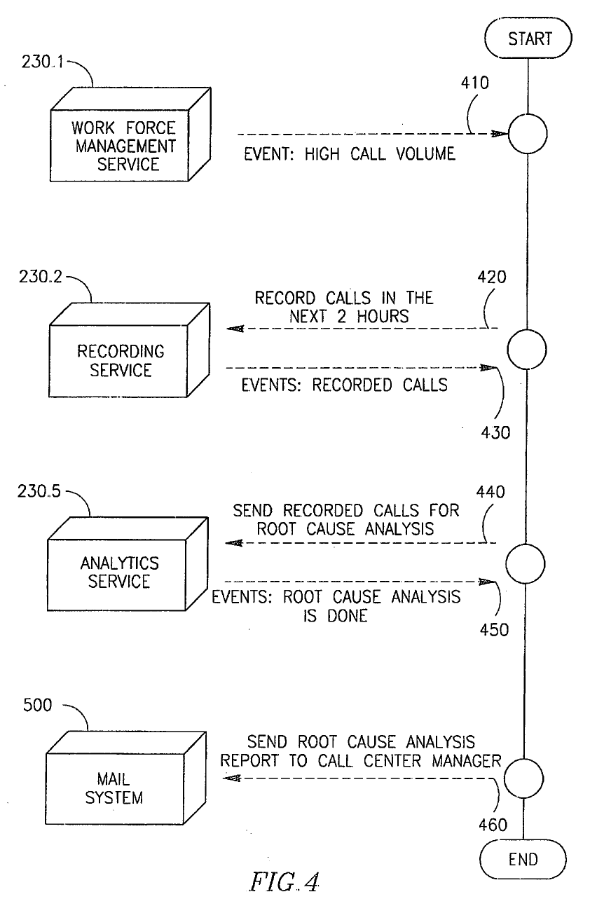

Reference is now made to FIG. 4, which depicts an exemplary business flow according to embodiments of the present invention. The exemplary business flow of FIG. 4 may enable a supervisor to analyze the reasons for high volumes of incoming telephone calls. The business flow is defined as follows: The flow may begin whereby, upon detection of volume of calls above a predefined value, work force management service 230.1 may send an event message notifying the high volume of calls over communication medium using a interaction management protocol (arrow 410).

Consequently, a request to record all calls during a predefine period of time may be sent to recording services 230.2 over communication medium 210 using the interaction management protocol (arrow 420). Upon completion of the requested recording, recording services 230.2 may send an event message notifying that the calls have been recorded over communication medium 210 using the interaction management protocol (arrow 430).

Next, a request to perform word spotting and categorization of these calls may be sent to content analysis service 230.5 over communication medium 210 using the interaction management protocol (arrow 440) As a result, content analysis service 230.5 may perform the content analysis and send an event message notifying the completion of the analysis over communication medium 210 using the interaction management protocol (arrow 450). Consequently, a message to a mail system 500 may be sent over communication medium 210 using the interaction management protocol (arrow 460). As a result, the mail system may send mail to a predefined recipient list possibly containing predefined content, for example, mail sent may contain the analysis results or it may contain other information pertaining to the execution of the flow

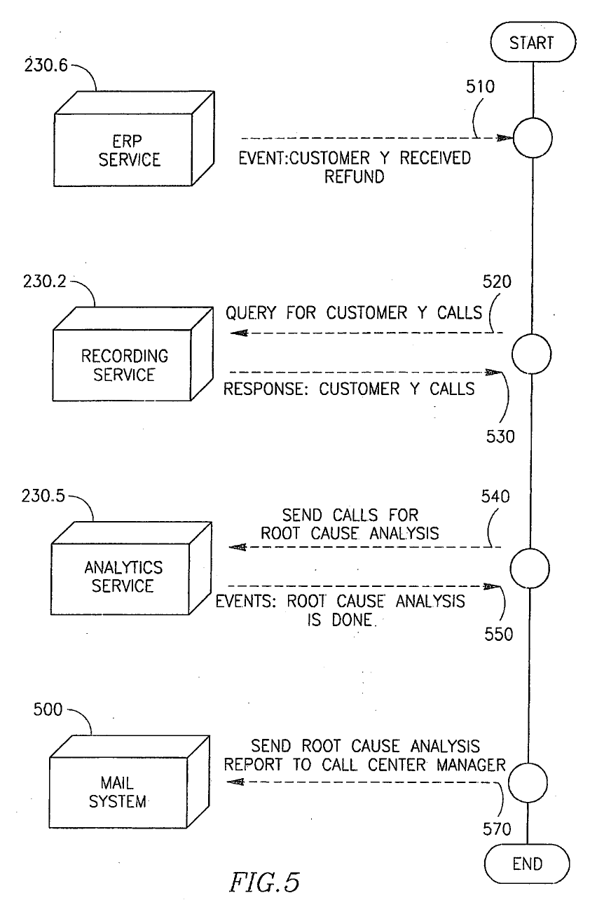

Reference is now made to FIG. 5, which depicts an exemplary business flow according to embodiments of the present invention. The exemplary business flow of FIG. 5 may enable a supervisor to analyze agent-client telephonic interaction that involved refunding the client at an amount above a predefined value. The business flow is defined as follows: First, using an Enterprise Resource Planning (ERP) service 230.6, a datum related to a customer being refunded above a predefined value is detected (arrow 510) and an event message notifying the finding is being sent over communication medium 210 using the interaction management protocol

Consequently, a request for a search of all calls associated with that customer may be sent to recording services 230.2 over communication medium 210 using a interaction management protocol (arrow 520). Recording services 230.2 may send the requested data to shared data storage and upon completion, recording services 230.2 may send over communication medium 210 using the interaction management protocol an event message notifying that the requested data was uploaded as requested (arrow 530).

Next, a request to perform word spotting and categorization of these calls may be sent to content analysis service 230.5 over communication medium 210 using the interaction management protocol (arrow 540). As a result, content analysis service 230.5 may perform the content analysis and send an event message notifying the completion of the analysis over communication medium 210 using the interaction management protocol (arrow 550).

Consequently, a message to a mail system 500 may be sent over communication medium 210 using the interaction management protocol (arrow 570). As a result, the mail system 500 may send mail to a predefined recipient list possibly containing predefined content, for example, mail sent may contain the analysis results or it may contain other information pertaining to the execution of the flow

While certain features of the invention have been illustrated and described herein, many modifications, substitutions, changes, and equivalents may occur to those skilled in the art It is, therefore, to be understood that the appended claims are intended to cover all such modifications and changes as fall within the true split of the invention.

What is claimed is:

1. A method for employing business flows in a contact center, the method comprising:
creating a business flow that utilizes one or more interaction-related autonomous business services, the business services communicate over a communication medium using an interaction management protocol; and
executing the business flow using the interaction management protocol.

2. The method of claim 1, wherein the interaction-related business services are to handle client-agent interactions.

3. The method of claim 1, wherein creating the business flow comprises utilizing two or more of the business services.

4. The method of claim 1, wherein creating the business flow comprises utilizing at least one of recording service, work force management service, performance management service, quality management service or content analysis service.

5. The method of claim 1, wherein the business flow comprises:
evaluating recorded client-agent interaction session of an agent using the quality management service; and
scheduling a meeting for the agent with a supervisor using the work force management service, if a predetermined condition is met.

6. The method of claim 1, wherein the business flow comprises:
recording client-agent interaction sessions using the recording service upon detection of high volumes of the client-agent interaction sessions by the work force management service;
automatically issuing an analysis report using an analysis service based on the recorded client-agent interaction sessions; and
automatically sending the analysis report to a call center manager using the mailing service.

7. The method of claim 1, wherein the business flow comprises:
automatically sending a query to a recording service requesting recorded client-agent interaction session for a particular client upon receiving a notification from an enterprise resource planning service that the particular client was refunded;
automatically issuing an analysis report using an analysis service based on the recorded client-agent inter action sessions; and
automatically sending the analysis report to a call center manager using the mailing service.

8. The method of claim 1, wherein creating the business flow enables automatic scheduling of a meeting between an agent and a supervisor upon receiving a notification that an evaluation of a client-agent interaction session of the agent was performed.

9. The method of claim 1, wherein creating the business flow enables automatic issuance and distribution of an analysis report associated with client-agent interaction sessions of a particular client upon receiving a notification that the client was refunded.

10. The method of claim 1, wherein creating the business flow enables automatic issuance and distribution of an analysis report upon detection of a high volume of client-agent interaction sessions above a predefined threshold.

11. A platform for enabling collaboration of components of a distributed interaction-related loosely-coupled system in a contact center environment, the platform comprising:
a communication medium;
one or more interaction-related autonomous business services capable of communicating via the communication medium using an interaction management protocol; and
one or more business process management services to create one or more business flows that utilize one or more of the business services.

12. The platform of claim 11, wherein at least one business flow is a predefined business flow.

13. The platform of claim 11, wherein the interaction-related business services are to handle client-agent interactions.

14. The platform of claim 11, wherein the interaction-related business services are to handle internal interactions of personnel of the contact center.

15. The platform of claim 11, wherein the interaction-related business services are recording service, work force management service, performance management service, quality management service or content analysis service.

16. The platform of claim 11, wherein the business flows are initiated by an operator.

17. The platform of claim 11, wherein the business flows are initiated periodically.

18. The platform of claim 11, wherein said business flows are initiated by the business services.

19. The platform of claim 11, wherein the business flows are defined by an operator.

20. The platform of claim 11, further comprising shared data storage coupled to the communication medium.

21. The platform of claim 11, where the platform is arranged in a service oriented architecture.

22. The platform of claim 11, wherein at least one of the business flows is customized according to system requirements.
